(19) United States
(12) Patent Application Publication
(10) Pub. No.: US 2026/0062845 A1
(43) Pub. Date: Mar. 5, 2026

(54) REINFORCEMENT MATERIAL FOR FOAM-MOLDED PRODUCT, MOLDED PRODUCT, AND METHOD OF PRODUCING MOLDED PRODUCT

(71) Applicant: Ohtsuka Sangyo Material Co., Ltd., Nagahama-Shi (JP)

(72) Inventors: Ryotaro TSUJI, Higashiomi-Shi (JP); Motoyoshi OHTSUKA, Nagahama-Shi (JP)

(21) Appl. No.: 19/306,275

(22) Filed: Aug. 21, 2025

(30) Foreign Application Priority Data
Aug. 28, 2024 (JP) 2024-146095

(51) Int. Cl. D04H 1/488; B29C 43/00; B29C 43/02; B29K 67/00; B29K 105/00; B29L 31/00; D04H 1/435; D04H 1/4382

(52) U.S. Cl. CPC D04H 1/488; B29C 43/003; B29C 43/02; D04H 1/435; D04H 1/43835; B29K 2067/003; B29K 2105/256; B29K 2995/0077; B29K 2995/0093; B29L 2031/771; D10B 2401/021; D10B 2401/063; D10B 2505/08

(57) ABSTRACT

A reinforcement material for a foam-molded product, being capable of being molded into a predetermined three-dimensional shape by press molding, wherein the reinforcement material has a nonwoven fabric layer formed with first short fiber and second short fiber interlaced, wherein the first short fiber is binder short fiber, and at least part of a surface of the second short fiber has a water repellent layer, and wherein a mixing fiber ratio of the binder short fiber and the second short fiber is from 20:80 to 80:20. The molded product is obtained by press-molding the reinforcement material.

### INCORPORATION BY REFERENCE TO ANY PRIORITY APPLICATIONS

Any and all applications for which a foreign or domestic priority claim is identified in the Application Data Sheet as filed with the present application are hereby incorporated by reference.

### FIELD

The present disclosure relates to a reinforcement material for a foam-molded product that can be molded into a predetermined three-dimensional shape by press molding, a molded product obtained by press molding the reinforcement material, and a method of producing the molded product.

### BACKGROUND

As a cushioning material for a vehicle seat (seat) or the like, a foam-molded product such as urethane foam is used. A reinforcement material may be disposed on the surface of such a foam-molded product. For example, a reinforcement material including a nonwoven fabric layer is disposed on a cushioning material of a vehicle seat for the purpose of preventing reduction in rigidity of the cushioning material and preventing frictional sound generated by friction between the cushioning material and a spring (Japanese Utility Model Registration No. 3207739 and WO 2015/034069 A).

When the foam-molded product is produced, a reinforcement material is press-molded so as to match the shape of a mold for the foam-molded product to obtain a molded product, and thereafter, the molded product is disposed in the mold, a foaming component is poured, and the foaming component is foamed under heating and pressurization to obtain a foam-molded product. When the foaming component is poured or foamed, the foaming component may penetrate through the reinforcement material and ooze out. When the foam-molded product in which such oozing has occurred is used as a cushioning material of a vehicle seat, there is a problem that frictional sound is generated by friction between the oozed foaming component and a spring.

As a reinforcement material for suppressing oozing of a foaming component at the time of molding, Japanese Utility Model Registration No. 3150605 discloses a urethane reinforcement material which is a nonwoven fabric formed of a mixture of crimpable composite short fiber and water repellent short fiber, in which a mixing fiber ratio of the water repellent short fiber and the crimped composite short fiber is in a range of 3/97 to 40/60, and a mass per unit area, a 50% elongation stress, and a breaking elongation are in specific ranges.

### SUMMARY

As described above, the reinforcement material is press-molded so as to match the shape of a mold for a foam-molded product. Therefore, the reinforcement material is required to have high extensibility so as to be molded into a predetermined three-dimensional shape during press molding. In addition, in recent years, a foam-molded product having a projection-recess shape is required, and when such a foam-molded product is produced, a mold having a deep projection-recess is used. In such a mold having a deep projection-recess, when the reinforcement material does not sufficiently follow the mold, the reinforcement material cannot be manufactured with a uniform thickness, and the reinforcement material is partially thinned or broken, so that the foaming component easily oozes out, or the reinforcement material and the foam-molded product do not have a predetermined three-dimensional shape. Therefore, a reinforcement material capable of coping with a mold having a deep projection-recess and suppressing oozing of the foaming component is required.

Japanese Utility Model Registration No. 3150605 does not refer to molding a urethane reinforcement material into a predetermined three-dimensional shape by press molding. In the urethane reinforcement material described in Japanese Utility Model Registration No. 3150605, a load at 50% elongation is identified to 1.0 to 15.0 N/5 cm. This characteristic indicates that the urethane reinforcement material extends with a weak force. In view of these disclosures, the urethane reinforcement material described in Japanese Utility Model Registration No. 3150605 is considered to be disposed in a mold and molded by urethane at a time without being molded into a predetermined three-dimensional shape by press molding in advance. However, such a reinforcement material has a problem that followability to a projection-recess of a mold is poor, the reinforcement material cannot be applied to a mold having a deep projection-recess, and suppression of oozing in a foam-molded product having a deep projection-recess is not sufficient.

An object of the present disclosure is to provide a reinforcement material for a foam-molded product which is excellent in followability to a mold, particularly followability to a mold having a deep projection-recess, and is capable of suppressing oozing of a foaming component, a molded product obtained by press-molding the reinforcement material, and a method of producing the molded product.

A reinforcement material (hereinafter, referred to as “the present reinforcement material”) of the present disclosure is a reinforcement material for a foam-molded product that can be molded into a predetermined three-dimensional shape by press molding, the reinforcement material including a nonwoven fabric layer formed with first short fiber and second short fiber interlaced, wherein the first short fiber is binder short fiber, at least part of a surface of the second short fiber has a water repellent layer, and a mixing fiber ratio of the first short fiber and the second short fiber is from 20:80 to 80:20 (which can be expressed as (20 to 80)/(80 to 20)).

The molded product (hereinafter, the molded product is referred to as “the present molded product”) of the present disclosure is a molded product obtained by press-molding the present reinforcement material. The method of producing a molded product of the present disclosure includes the steps of heating the present reinforcement material, and press-molding the heated present reinforcement material.

### Advantageous Effects

The reinforcement material for the foam-molded product and the molded product of the present disclosure are excellent in followability to a mold, particularly followability to a mold having a deep projection-recess, and in the foam-molded product by such a mold, it is possible to suppress oozing of a foaming component. In the method of producing a molded product of the present disclosure, a molded product having excellent followability to a mold can be obtained.

The present reinforcement material has a nonwoven fabric layer formed with first short fiber and second short fiber interlaced. The method of interlacing the first short fiber and the second short fiber is not particularly limited, and a known method of producing a nonwoven fabric can be applied. The first short fiber and the second short fiber can usually be interlaced by a needle punch method.

The first short fiber is binder short fiber. In the present reinforcement material, when molded into a predetermined three-dimensional shape by press molding, at least part of the binder component in the short fiber is melted by heat, so that fibers constituting the nonwoven fabric can be partially bonded to each other. As a result, the three-dimensional shape of the reinforcement material after press molding can be stabilized.

The configuration of the binder short fiber is not particularly limited as long as the binder short fiber contains a binder component at least partially melted by heat to partially bond the fibers constituting the nonwoven fabric to each other. The binder short fiber is usually composed of two components of a high melting point component and a low melting point component which is a binder component. More specifically, examples of the binder short fiber include short fiber having a core-sheath structure composed of a core portion as a high melting point component and a sheath portion as a low melting point component.

When the binder short fiber contains a high melting point component and a low melting point component, the blending ratio of both is not particularly limited. The blending ratio (by weight) of the high melting point component and the low melting point component is usually (30 to 70)/(70 to 30). When the blending ratio is within the above range, extensibility, particularly extensibility at a high temperature is high, and it is easier to follow a deep mold, which is preferable.

The “low melting point” of the low melting point component means a melting point lower than the temperature at the time of press molding or a melting point of 90° C. to 150° C. The “high melting point” of the high melting point component means a melting point higher than the temperature at the time of press molding or a melting point of 200° C. to 300° C.

At least part of the surface of the second short fiber has a water repellent layer. The method of forming the water repellent layer is not particularly limited. Examples of the method include a method in which the first fiber and the second fiber are interlaced and then subjected to a water repellent treatment, and a method in which the water repellent short fiber is used as the second short fiber and is interlaced with the first short fiber. The water repellent short fiber is fiber in which a water repellent layer is formed on at least part of a fiber surface by subjecting the short fiber to a water repellent treatment. Examples of the water repellent treatment include a silicone treatment and a fluorine treatment.

The material of the first short fiber and the second short fiber is not particularly limited. Examples of the material include polyester, polyethylene, and polypropylene. The material is preferably polyester. The first short fiber and the second short fiber may be made of the same material or different materials. The high melting point component and the low melting point component may be made of the same material or different materials. Further, when the binder short fiber is fiber having a core-sheath structure, the core portion and the sheath portion may be made of the same material or different materials. Specific examples of the binder short fiber include short fiber composed of high melting point polyester and low melting point polyester, and particularly short fiber composed of a core portion which is high melting point polyester and a sheath portion which is low melting point polyester.

The length of each of the first short fiber and the second short fiber is usually 75 mm or less. The lower limit value of the length is not particularly limited, but is usually 20 mm or more, and preferably 30 mm or more. When the length is in the above range, it is preferable that the interlacement of the first short fiber and the second short fiber is increased, and the tensile strength of the nonwoven fabric layer is improved. The fiber diameter of each of the first short fiber and the second short fiber is usually 8 dtex or less, and preferably 4 dtex or less. The lower limit value of the fiber diameter is not particularly limited, but is usually 3 dtex or more. The lengths and/or the fiber diameters of the first short fiber and the second short fiber may be the same or different.

The mixing fiber ratio (by weight) of the first short fiber and the second short fiber is (20 to 80)/(80 to 20), preferably (30 to 70)/(70 to 30), and more preferably (35 to 65)/(65 to 35). The upper limit value and the lower limit value of the mixing fiber ratio may be any integer values within the above numerical range. When the amount of the first short fiber is excessive, the reinforcement material may adhere to a mold during press molding, which is not preferable. When the amount of the first short fiber is too small, the rigidity after press molding is insufficient, and the three-dimensional shape of the foam-molded product may not be stabilized, which is not preferable.

The blending ratio of the first short fiber and the second short fiber in the fiber raw material is not particularly limited, and can be set to an appropriate range. The blending ratio (by weight) of the first short fiber and the second short fiber is usually independently 20 to 80%, preferably 30% to 70%, and more preferably 30 to 65%. The upper limit value and the lower limit value of the blending ratio can be any integer values within the above numerical range.

By having the above configuration, the present reinforcement material has high extensibility, particularly extensibility at a high temperature, and is excellent in moldability by heating and shape retention during cooling. Specifically, the present reinforcement material preferably has a load at 75% elongation in a high-temperature tensile test of 100 N/5 cm or less, preferably 90 N/5 cm or less. In addition, in the present reinforcement material, the difference between the load at 75% elongation and the tensile strength in a high-temperature tensile test is 60 N/5 cm or more, preferably 70 N/5 cm or more, and more preferably 80 N/5 cm or more. When the difference between the load at 75% elongation and the load at 75% elongation and the tensile strength is within the above range, the extensibility at high temperature is high and followability is excellent even in a mold having a deep projection-recess, and as a result, in a foam-molded product obtained by the mold having a deep projection-recess, oozing of the foaming component can be suppressed, which is preferable. The load at 75% elongation and tensile strength in the high-temperature tensile test is a value measured by the method and condition of the tensile test at 140° C. described in the section of Example.

The load at 5% elongation of the present reinforcement material is preferably 10 N/5 cm or more, and preferably 15 N/5 cm or more. When the load at 5% elongation is within the above range, the present reinforcement material can be automatically inserted into a mold by a machine in press molding, which is preferable. The “load at 5% elongation” is a value measured by the method and condition of the tensile test at 25° C. described in the section of Example.

The difference between the load at 75% elongation and the load at 75% elongation and the tensile strength can be appropriately adjusted by the blending ratio of the binder short fiber in the raw material fiber, the punch density in interlacement by the needle punch method, and the needle depth. For example, when the blending ratio of the binder short fiber in the raw material fiber is increased, the load at 75% elongation can be reduced, and the difference between the load at 75% elongation and the tensile strength can be increased. When the punch density and the needle depth in the interlacement by the needle punch method are increased, the tensile strength can be increased, and the difference between the load at 75% elongation and the tensile strength can be increased.

The present reinforcement material may contain one kind or two or more kinds of fibers other than the first short fiber and the second short fiber as long as the action of the present disclosure is not hindered. Examples of the another fiber include known antibacterial fiber, flame retardant fiber, and hygroscopic heat generating fiber. The blending ratio (by weight) of the another fiber in the fiber raw material is usually 5 to 40%, preferably 10% to 30%. The upper limit value and the lower limit value of the blending ratio can be any integer values within the above numerical range.

The present reinforcement material has a nonwoven fabric layer formed with the first short fiber and the second short fiber interlaced. The present reinforcement material may be composed of only the nonwoven fabric layer, and may include another layer as long as the action of the present disclosure is not hindered. The weight per unit area, thickness, and air permeability of the nonwoven fabric are not particularly limited, and can be set to appropriate values as necessary. The weight per unit area of the nonwoven fabric is usually 80 to 150 g/m², preferably 100 to 140 g/m². The air permeability is usually 120 to 200 cm³/(cm²·s), preferably 140 to 180 cm³/(cm²·s). The upper limit value and the lower limit value of the weight per unit area and the air permeability can be any integer values within the above numerical range. The thickness of the nonwoven fabric is usually 0.8 to 3 mm, preferably 1.5 to 2.5 mm. The lower limit value of the thickness range can be 0.9 mm, 1 mm, 1.2 mm, 1.4 mm, or 1.6 mm. The upper limit value of the thickness can be 2.9 mm, 2.8 mm, 2.7 mm, 2.6 mm, or 2.4 mm. The range of the thickness can be a range obtained by appropriately combining the above numerical values. The air permeability is a value measured based on JIS L1906 Frazier method.

The material and type of the foam-molded product are not particularly limited. Examples of the material of the foam-molded product include urethane. Specific examples of the foam-molded product include a cushioning material, more specifically, a cushioning material of a vehicle seat. The foam-molded product can be usually obtained by press-molding the present reinforcement material so as to match the shape of a mold for the foam-molded product to obtain the present molded product, disposing the present molded product in the mold, pouring a foaming component, and then foaming the foaming component.

The present molded product is obtained by press-molding the present reinforcement material. The method and conditions of the press molding are not particularly limited as long as the present reinforcement material can be molded. The press molding is usually press molding using a mold. The press molding may be cold press molding (press molding for heating a material) or hot press molding (press molding for heating a mold). Specifically, the present molded product can be obtained, for example, by a method including the steps of heating the present reinforcement material and press-molding the heated present reinforcement material.

### DETAILED DESCRIPTION

### Example

Hereinafter, the present disclosure will be specifically described with reference to Example. Note that the present disclosure is not limited to the embodiments described in the Example. The embodiments of the present disclosure can be variously modified within the scope of the present disclosure according to the purpose and use.

### 1. Production of Reinforcement Material

The following fiber was used as raw material fiber.

### (1) Binder Fiber

Two-component polyester fiber (thickness: 4.0 dtex, length: 5.1 cm) containing 50 mass % of low melting point polyester (melting point: 110° C.) as a low melting point component and 50 mass % of high melting point polyester (melting point: 260° C.) as a high melting point component.

### (2) Water Repellent Fiber

Fiber (thickness: 2.0 dtex, length: 5.1 cm) obtained by applying a fluorine-based oil agent to high melting point polyester fiber (melting point: 260° C.) and subjecting the fiber to a water repellent treatment.

### (3) Another Fiber

High melting point polyester fiber (melting point: 260° C.) (thickness: 2.0 dtex, length: 5.1 cm).

Raw material fiber composed of the (1) binder fiber, the (2) water repellent fiber, and the (3) another fiber were passed through a carding machine to prepare a web. The web was stacked in a cross layer to produce a stacked web. The stacked web was needle-punched to interlace the respective fibers, thereby producing a reinforcement material of Example which is a needle-punched nonwoven fabric. The blending ratio (by weight) of the (1) binder fiber, the (2) water repellent fiber, and the (3) another fiber are shown in Table 1.

A reinforcement material of Comparative Example was prepared by the same method as in Example except for using (1) binder fiber and (3) another fiber as raw material fiber. The blending ratio (by weight) of the (1) binder fiber and the (3) another fiber are shown in Table 1.

### 2. Evaluation Method

### A. Thickness, Weight Per Unit Area, and Density

The thickness and the weight per unit area of each of the reinforcement materials of Example and Comparative Example were measured. In addition, the air permeability of each of the reinforcement materials of Example and Comparative Example was measured based on JIS L1906 Frazier method. The results are shown in Table 1.

### B. Tensile Test

The mechanical properties of the reinforcement material at 25° C. and 140° C. were examined using a tensile tester (Autograph AGS-5kNX manufactured by Shimadzu Corporation). The results are shown in Table 1.

The tensile test at 25° C. was performed according to the following procedure. A rectangular test piece having a length of 200 mm and a width of 50 mm was cut out from the reinforcement materials of Example and Comparative Example (see FIG. 4 of JP 2023-106813 A). As test pieces, a test piece in which the flow direction (hereinafter, the direction is referred to as an “MD direction”) of the manufacturing process was the longitudinal direction (tensile direction) and a test piece in which the direction (hereinafter, the direction is referred to as a “CD direction”) perpendicular to the MD direction was the longitudinal direction were prepared. Chucks having a width of 20 mm were attached to both ends of the test piece, and the test piece was set so that the gauge length was 100 mm. A tensile test was performed at a tensile rate of 100 mm/min, and the tensile strength (N/50 mm) when the test piece was elongated by 5%, 30%, 50%, 75%, and 100%, and the tensile strength at break (N/50 mm) and the breaking elongation (mm) were measured. A tensile test in the MD direction was performed three times, a tensile test in the CD direction was performed three times, and a total of six times of tensile tests were performed, and an arithmetic average value of the six measured values in total was used as each tensile strength (maximum load) and breaking elongation. The coefficient of extension φ ((%) was calculated as φ={(L-L0)/L0}×100, where L0 (=100 mm) was a gauge length before the test, and L was a gauge length after breaking (breaking elongation).

The tensile test at 140° C. was performed according to the following procedure (see FIG. 5 of JP 2023-106813 A). A rectangular test piece having a length of 200 mm and a width of 50 mm was cut out from the reinforcement materials of Example and Comparative Example in the same manner as in the tensile test at 25° C. Two hair irons each having a pair of holding portions and a width of the holding portion of 25 mm were prepared. Two hair irons were placed adjacent to each other and fixed with a fixture so as not to be separated from each other. The width of the holding portion is 50 mm in total. When the cushion sheet was bonded to the inside of the holding portion and the pair of holding portions was closed, the pair of holding portions did not come into contact with each other, and a gap of 3 mm to 5 mm was formed between the pair of holding portions. The center of the test piece set in the tensile tester was sandwiched between two hair irons heated to 140° C. and maintained for 10 seconds. As described above, since the total width of the holding portion is 50 mm, the test piece is also heated over a width of 50 mm. Further, since there is a gap between the pair of holding portions, each holding portion of the hair iron is not brought into contact with the test piece. After a lapse of 10 seconds, a tensile test was performed under the same method and conditions as those of the tensile test at 25° C. (however, a load at 5% elongation is excluded) with the test piece sandwiched between hair irons.

### C. Water Repellency Test

The test was performed according to “JIS L 1092 spray test”. The number of test pieces was N=3 in each of Example and Comparative Example.

### D. Evaluation of Urethane Oozing

The reinforcement materials of Example and Comparative Example were press-molded so as to match the shape of a mold for a foam-molded product (shape conforming to a portion close to headrest stay attachment portion on back side of automobile front seat). Thereafter, the reinforcement material after molding was disposed in a mold for a foam-molded product, urethane as a foaming component was poured, and the foaming component was foamed under heating and pressurization to produce foam-molded products of Example and Comparative Example as cushioning materials. For the produced foam-molded product (N=5), the presence or absence of oozing to the back face of the reinforcement material was visually confirmed. The squeaking noise was confirmed by disposing the foam-molded product at a position close to the headrest stay attachment portion on the back side of the automobile front seat and pressing a human hand or body against the foam-molded product. These results are shown in Table 1.

TABLE 1

| | | | | Comparative |
|---|---|---|---|---|
| | | | EXAMPLE | Example |
| Raw material | Water | | 40% | 0% |
| fiber | repellent | | | |
| | fiber | | | |
| | Binder fiber | | 40% | 40% |
| | Another | | 20% | 60% |
| | fiber | | | |
| Basic | Weight per | g/m² | 135.4 | 150.5 |
| physical | unit area | | | |
| property test | | | | |
| | Thickness | mm | 1.95 | 2.04 |
| | Air | cm³/ | 164.6 | 152.1 |
| | permeability | (cm² · s ) | | |
| | Water | | First grade to | First grade |
| | repellency | | second grade | |
| | test | | No back face | With back |
| | | | impregnation | face |
| | | | | impregnation |
| 25° C. | Load at 5% | N/5 cm | 19.1 | 18.1 |
| Tensile test | elongation | | | |
| | Load at 30% | N/5 cm | 33.8 | 47.0 |
| | elongation | | | |
| (Average in | Load at 50% | N/5 cm | 54.5 | 77.5 |
| MD and CD | elongation | | | |
| directions) | | | | |
| | Load at 75% | N/5 cm | 94.2 | 126.6 |
| | elongation | | | |
| | Load at 100% | N/5 cm | 141.6 | — |
| | elongation | | | |
| | Tensile | N/5 cm | 191.0 | 163.5 |
| | strength | | | |
| | Coefficient of | % | 122.2 | 98.8 |
| | extension | | | |
| 140° C. | Load at 30% | N/5 cm | 19.0 | 25.2 |
| Tensile test | elongation | | | |
| (Average in | Load at 50% | N/5 cm | 42.0 | 57.8 |
| MD and CD | elongation | | | |
| directions) | | | | |
| | Load at 75% | N/5 cm | 82.4 | 111.0 |
| | elongation | | | |
| | Load at 100% | N/5 cm | 132.2 | — |
| | elongation | | | |
| | Tensile | N/5 cm | 174.3 | 160.7 |
| | strength | | | |
| | Coefficient of | % | 122.7 | 105.1 |
| | extension | | | |
| Urethane | Evaluation | (N | N = 5 points | N = 5 points |
| oozing | score | number) | | |
| evaluation | Evaluation item | | | |

| Oozing to back face | Not generated | Partially |
|---|---|---|
| | | generated |
| Squeaking noise | Not generated | Partially |
| | | generated |
| Overall evaluation | Good | Partially no |

good
In Table 1, “—” means that there is no measurement result of “load at 100% elongation” because the coefficient of extension of some test pieces was less than 100%.

### 3. Results

From Table 1, in the reinforcement materials of Example, impregnation of urethane to the back face was not recognized, and squeaking noise with a spring did not occur. On the other hand, in the reinforcement material of Comparative Example, the back face was impregnated with urethane, and when the reinforcement material was disposed as a cushioning material in a vehicle, a squeaking noise with a spring was generated. The grade of water repellency was also lower than that of Example. These results indicate that the reinforcement material of Example is excellent in the effect of suppressing oozing of the foaming component.

From Table 1, it can be seen that the reinforcement material of Example has a low load at elongation, high tensile strength and high coefficient of extension, and excellent extensibility at both normal temperature (25° C.) and high temperature (140° C.) as compared with the reinforcement materials of Comparative Example. Specifically, the load at 75% elongation in the high-temperature (140° C.) tensile test of the reinforcement material of Example is lower than that of the reinforcement material of Comparative Example, and the difference between the load at 75% elongation and the tensile strength in the high-temperature tensile test is large (Example; 91.9 N/5 cm, Comparative Example; 49.7 N/5 cm). This result indicates that the reinforcement material of Example is excellent in moldability by heating and shape retention at the time of cooling, and as a result, is excellent in followability to a mold having a deep projection-recess, so that it is possible to suppress oozing of the foaming component even in a foam-molded product having a deep projection-recess.

What is claimed is:

1. A reinforcement material for a foam-molded product, the reinforcement material being capable of being molded into a predetermined three-dimensional shape by press molding,
wherein the reinforcement material has a nonwoven fabric layer formed with first short fiber and second short fiber interlaced,
wherein the first short fiber is binder short fiber, and at least part of a surface of the second short fiber has a water repellent layer, and
wherein a mixing fiber ratio of the first short fiber and the second short fiber is from 20:80 to 80:20.

2. The reinforcement material according to claim 1, wherein a load at 75% elongation in a high-temperature tensile test is 100 N/5 cm or less, and a difference between a load at 75% elongation and a tensile strength in a high-temperature tensile test is 60 N/5 cm or more.

3. The reinforcement material according to claim 1, wherein the foam-molded product is a cushioning material.

4. The reinforcement material according to claim 1, wherein the second short fiber is water repellent short fiber.

5. A molded product obtained by press-molding the reinforcement material according to claim 1.

6. A method of producing a molded product, the method comprising:
heating the reinforcement material according to claim 1 to obtain a heated reinforcement materials; and
press-molding the heated reinforcement material.
